(19) United States
(12) Patent Application Publication
(10) Pub. No.: US 2026/0371325 A1
(43) Pub. Date: Nov. 19, 2026

(54) DEVICES, METHODS, AND MEDIUM FOR COMMUNICATION

(71) Applicant: NEC Corporation, Tokyo (JP)

(72) Inventors: Lin LIANG, Beijing (CN); You LI, Beijing (CN); Lei CHEN, Beijing (CN); Gang WANG, Beijing (CN)

(73) Assignee: NEC Corporation, Tokyo (JP)

(21) Appl. No.: 19/153,812

(22) PCT Filed: Feb. 6, 2023
(86) PCT No.: PCT/CN2023/074644

§ 371 Date: Aug. 5, 2025

(51) Int. Cl. H04W 72/0453; H04W 72/231; H04W 72/563; H04W 74/0833; H04W 76/20

(52) U.S. Cl. CPC H04W 72/0453; H04W 72/231; H04W 72/563; H04W 74/0833; H04W 76/20

(57) ABSTRACT

Example embodiments of the present disclosure relate to devices, methods, and computer storage medium for communication. A terminal device receives a configuration comprising a first threshold associated with a logical channel or a logical channel group; determines whether buffered data of the logical channel comprise delayed data based on the configuration; determines a priority value of the logical channel; and performs an LCP procedure based on the priority value of the logical channel. As such, the priority order of delayed data may be increased so that the delayed data should be multiplexed in a MAC PDU with a high priority, thus the transmission of delayed data may be guaranteed. Therefore, the latency requirements of the services may be met and the efficiency of a communication between the terminal device and the network device may be improved.

### FIELD

Example embodiments of the present disclosure generally relate to the field of communication techniques and in particular, to devices, methods, and a computer readable medium for communication.

### BACKGROUND

Recently, a new work item on the enhancements for extended reality (XR) services is ongoing in new radio (NR) release 18 (Rel-18). To better schedule delay-sensitive traffic, a delay report of buffered data in uplink may be considered. A network device may schedule an uplink grant for delay-sensitive traffic according to the delay report. However, the current procedure cannot guarantee a successful transmission of delayed data, for example, certain protocol data unit (PDU) or PDU set may exceed a packet delay budget (PDB) or a PDU set delay budget (PSDB). Thus, an enhancement needs to be further studied.

### SUMMARY

In general, example embodiments of the present disclosure provide devices, methods, and a computer storage medium for communication.

In a first aspect, there is provided a terminal device. The terminal device comprises at least one processor configured to cause the terminal device at least to: receive, from a network device, a configuration comprising a first threshold associated with a logical channel or a logical channel group; determine whether buffered data of the logical channel comprise delayed data based on the configuration; in accordance with a determination that the buffered data of the logical channel comprise delayed data, determine a priority value of the logical channel; and perform a logical channel prioritization (LCP) procedure based on the priority value of the logical channel.

In a second aspect, there is provided a network device. The network device comprises at least one processor configured to cause the network device at least to: transmit, to a terminal device, a configuration comprising a first threshold associated with a logical channel or a logical channel group, the configuration being used by the terminal device for determining whether buffered data of the logical channel comprise delayed data; and receive, from the terminal device, an uplink transmission after a logical channel prioritization (LCP) procedure performed by the terminal device based on the configuration.

In a third aspect, there is provided a method of communication. The method comprises: receiving, at a terminal device from a network device, a configuration comprising a first threshold associated with a logical channel or a logical channel group, the logical channel group comprising the logical channel; determining whether buffered data of the logical channel comprise delayed data based on the configuration; in accordance with a determination that the buffered data of the logical channel comprise delayed data, determining a priority value of the logical channel; and performing a logical channel prioritization (LCP) procedure based on the priority value of the logical channel.

In a fourth aspect, there is provided a method of communication. The method comprises: transmitting, at a network device to a terminal device, a configuration comprising a first threshold associated with a logical channel or a logical channel group, the logical channel group comprising the logical channel, the configuration being used by the terminal device for determining whether buffered data of the logical channel comprise delayed data; and receiving, from the terminal device, an uplink transmission after a logical channel prioritization (LCP) procedure performed by the terminal device based on the configuration.

In a fifth aspect, there is provided a computer readable medium having instructions stored thereon, the instructions, when executed on at least one processor, causing the at least one processor to carry out the method according to the third or the fourth aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented;

FIG. 2 illustrates a signalling chart illustrating communication process in accordance with some embodiments of the present disclosure;

FIG. 3A illustrates a schematic diagram of a scenario with two logical channels in accordance with some embodiments of the present disclosure;

FIG. 3B illustrates another schematic diagram of another scenario with two logical channels in accordance with some embodiments of the present disclosure;

FIG. 4 illustrates a flowchart of an example method implemented at a terminal device in accordance with some embodiments of the present disclosure;

FIG. 5 illustrates a flowchart of an example method implemented at a network device in accordance with some embodiments of the present disclosure; and

FIG. 6 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio (NR) Access, Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the 1G, 2G, 2.5G, 2.75G, 3G, 4G, 4.5G, 5G, 5.5G, 5G-Advanced networks, or 6G networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

It is agreed that delay reporting of buffered data in uplink shall be considered for better scheduling delay-sensitive traffic of XR services. For example, some work items in Rel-18 specify the enhancements related to capacity of: buffer status report (BSR) enhancements including at least new BS table(s), and delay reporting of buffered data in uplink.

A UE may perform an uplink transmission to the network. The logical channel prioritization (LCP) procedure is applied whenever a new transmission is performed. The radio resource control (RRC) controls the scheduling of uplink data by signalling for each logical channel (LCH) per medium access control (MAC) entity:
priority where an increasing priority value indicates a lower priority level;
prioritisedBitRate which sets the Prioritized Bit Rate (PBR); and
bucketSizeDuration which sets the Bucket Size Duration (BSD).

The following UE variable is used for the Logical channel prioritization procedure:
Bj which is maintained for each logical channel j.

The MAC entity shall initialize Bj of the logical channel to zero when the logical channel is established. For each logical channel j, the MAC entity shall:
1> increment Bj by the product PBR×T before every instance of the LCP procedure, where T is the time elapsed since Bj was last incremented;
1> if the value of Bj is greater than the bucket size (i.e. PBR×BSD):
   2> set Bj to the bucket size.

It is noted that the exact moment(s) when the UE updates Bj between LCP procedures is up to UE implementation, as long as Bj is up to date at the time when a grant is processed by LCP.

Some XR services may have strict latency requirements. Since any data which have an exceeded PDB/PSDB may not be useful, the uplink resources should be allocated before then. When the remaining delay budget is explicitly provided to the network, the network may have flexibility to schedule the uplink grant considering the remaining delay budget without exceeding the PDB/PSDB. Although the network can schedule UL grant for delay sensitive traffic according to the remaining delay budget and/or the delayed buffer size, the current LCP procedure cannot guarantee that delayed data shall be multiplexed in the corresponding MAC PDU, which may still lead to certain PDU/PDU Sets exceed the PDB/PSDB.

Embodiments of the present disclosure provide a solution of communication. In the solution, a terminal device may receive a configuration from the network device, where the configuration may include a first threshold associated with a logical channel (LCH) or a logical channel group (LCG). The terminal device may determine delayed data and/or non-delayed data of the LCH/LCG based on the configuration, and further determine a priority value for further LCP procedure. As such, the delayed data may be multiplexed in a MAC PDU with a higher priority, and thus an issue that the delayed data exceeding a delay budget may be solved. Therefore, the latency requirements of the services may be guaranteed and the efficiency of a communication between the terminal device and the network device may be improved. Principles and implementations of the present disclosure will be described in detail below with reference to the figures.

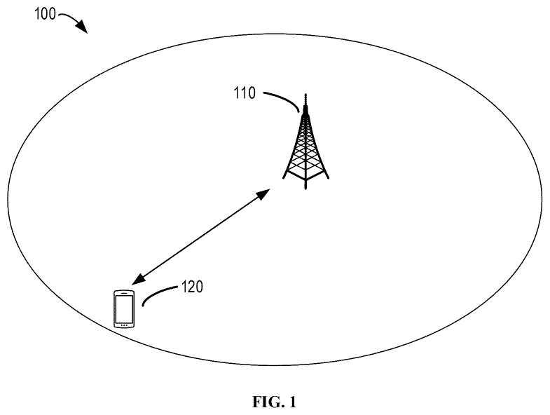

FIG. 1 illustrates an example communication system 100 in which some embodiments of the present disclosure can be implemented. The communication network 100 includes a network device 110 and a terminal device 120. The network device 110 can provide services to the terminal device 120.

In the system 100, it is assumed that the terminal device 120 is located within coverage of the network device 110. In some examples, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting TX device (or a transmitter) and the network device 110 is a RX device (or a receiver). In some embodiments, the network device 110 and the terminal device 120 may communicate with direct links/channels. DL may comprise one or more logical channels, including but not limited to a Physical Downlink Control Channel (PDCCH) and a Physical Downlink Shared Channel (PDSCH). UL may comprise one or more logical channels, including but not limited to a Physical Uplink Control Channel (PUCCH) and a Physical Uplink Shared Channel (PUSCH). As used herein, the term “channel” may refer to a carrier or a part of a carrier consisting of a contiguous set of resource blocks (RBs) on which a channel access procedure is performed in shared spectrum.

Communications in the system 100, between the network device 110 and the terminal device 120 for example, may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHZ, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

It is to be understood that the numbers of devices (i.e., the network device 110 and the terminal device 120) and their connection relationships and types shown in FIG. 1 are only for the purpose of illustration without suggesting any limitation. The system 100 may include any suitable numbers of devices adapted for implementing embodiments of the present disclosure.

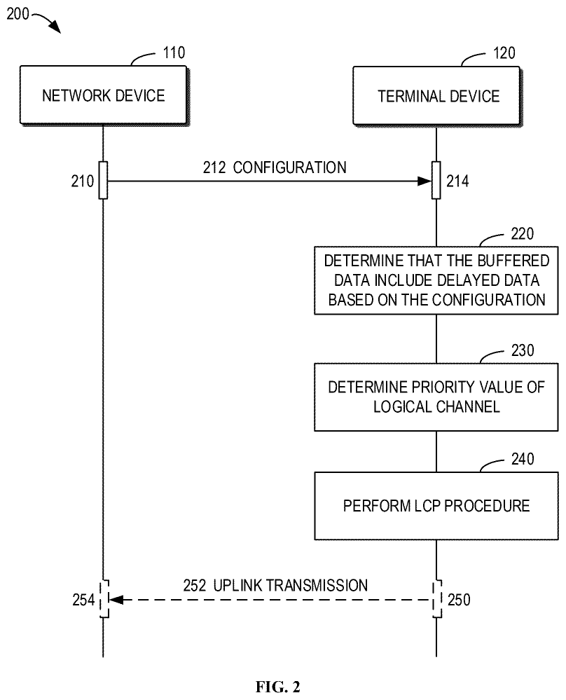

Reference is further made to FIG. 2, which illustrates a signalling chart illustrating communication process 200 in accordance with some example embodiments of the present disclosure. Only for the purpose of discussion, the process 200 will be described with reference to FIG. 1. The process 200 may involve the network device 110 and the terminal device 120.

The network device 110 transmits 210 a configuration 212 to the terminal device 120. In some example embodiments, the configuration 212 may include at least a first threshold associated with a logical channel (LCH) or a logical channel group (LCG). For example, the LCH may be associated with delay-sensitive traffic. For ease of description, the first threshold may be represented as T1. In some examples, the first threshold may relate to a delay or a remaining delay budget.

For ease of description, it is assumed that a first LCH (represented as LCH1) is associated with XR services with strict latency requirements. It is assumed that the first threshold is associated with the first LCH or a first LCG, where the first LCG may include multiple LCHs, and the multiple LCHs include LCH1. It is to be understood that this example is only for the purpose of illustration but without any limitation of the disclosure, some other cases may be applied and will not listed herein.

In some example embodiments, the configuration 212 may further include a second threshold associated with the LCH or the LCG. In some examples, the first threshold and the second threshold may be related to a delay. In some example embodiments, the first threshold and the second threshold may be used for determining delay levels (levels for brief) of the buffered data at the terminal device 120. For ease of description, the second threshold may be represented as T2, and it is assumed that T2<T1.

In some other example embodiments, the configuration 212 may further include a third threshold associated with the LCH or the LCG. In some examples, the first threshold and the third threshold may be related to a remaining delay budget. In some example embodiments, the first threshold and the third threshold may be used for determining delay levels of the buffered data at the terminal device 120. For ease of description, the third threshold may be represented as T3, and it is assumed that T3>T1.

It is to be understood that the configuration 212 may include more than two thresholds for determining more delay levels, but only for ease of description, two thresholds are discussed in the present disclosure.

In some example embodiments, the configuration 212 may be included in an RRC message or RRC signalling from the network device 110.

In some other example embodiments, the network device 110 may transmit a first configuration set and a second configuration set associated with the logical channel to the terminal device 120. In some examples, the first configuration set may be associated with delayed data, and the second configuration set may be associated with non-delayed data. In some examples, each of the configuration sets may include one or more of: a priority, a prioritized bit rate, a bucket size duration, or a logical channel group.

In some example embodiments, the network device 110 may further transmit information used for determining a priority value of the LCH, the information may be included in the configuration 212, or may be included in another message different from the configuration 212, the information used for determining the priority value will be described.

In some example embodiments, the terminal device 120 receives 214 the configuration 212. Accordingly, the terminal device 120 may obtain the first threshold. In some examples, the terminal device 120 may obtain the second or third threshold. The terminal device 120 may further determine whether the buffered data at the terminal device 120 include delayed data based on the configuration 212.

In some example embodiments, there is one threshold configured, in other words, the configuration 212 include the first threshold. The terminal device 120 may determine delayed data and/or non-delayed data based on the first threshold. In some examples, the first threshold is related to a delay. The terminal device may determine a delay of buffered data of the LCH. If the delay of buffered data exceeds (or is not less than) the first threshold, the terminal device 120 may determine that the buffered data are delayed data. If the delay of buffered data is not larger than (or is less than) the first threshold, the terminal device 120 may determine that the buffered data are non-delayed data. In some other examples, the first threshold is related to a remaining delay budget. The terminal device may determine a remaining delay budget of buffered data of the LCH. If the remaining delay budget of buffered data is not larger than (or is less than) the first threshold, the terminal device 120 may determine that the buffered data are delayed data. If the remaining delay budget of buffered data exceeds (or is not less than) the first threshold, the terminal device 120 may determine that the buffered data are non-delayed data.

In some other example embodiments, there may more than one threshold configured, for examples, the configuration 212 includes the first and second thresholds, or the configuration 212 includes the first and third thresholds. In some examples, the first threshold and the second threshold may be delay thresholds, i.e., they are related to a delay. The terminal device may determine a delay of buffered data of the LCH. If the delay of buffered data exceeds (or is not less than) the first threshold, the terminal device 120 may determine that the buffered data are delayed data with a first level. For example, if the delay ≥T1 or the delay ≥T1, the buffered data may be considered as delayed data with a first level (may be represented as level 1), such as urgent delayed data. If the delay of buffered data is not larger than (or is less than) the first threshold and exceeds (or is not less than) the second threshold, the terminal device 120 may determine that the buffered data are delayed data with a second level. For example, if T2<the delay≤T1 or T2≤the delay <T1, the buffered data may be considered as delayed data with a second level (may be represented as level 2), such as non-urgent delayed data. If the delay of buffered data is not larger than (or is less than) the second threshold, the terminal device 120 may determine that the buffered data are non-delayed data with level 3. For example, if the delay≤T2 or the delay <T2, the buffered data may be considered as non-delayed data with a third level (may be represented as level 3), such as non-delayed data.

In some other examples, the first threshold and the third threshold may be remaining delay budget thresholds, i.e., they are related to a remaining delay budget. The terminal device may determine a remaining delay budget of buffered data of the LCH. If the remaining delay budget of buffered data is not larger than (or is less than) the first threshold, the terminal device 120 may determine that the buffered data are delayed data with a first level. For example, if the remaining delay budget≤T1 or the remaining delay budget <T1, the buffered data may be considered as delayed data with a first level (may be represented as level 1), such as urgent delayed data. If the remaining delay budget of buffered data is not larger than (or is less than) the third threshold and exceeds (or is not less than) the first threshold, the terminal device 120 may determine that the buffered data are delayed data with a second level. For example, if T1<the remaining delay budget≤T3 or T1≤the remaining delay budget <T3, the buffered data may be considered as delayed data with a second level (may be represented as level 2), such as non-urgent delayed data. If the remaining delay budget of buffered data exceeds (or is not less than) the third threshold, the terminal device 120 may determine that the buffered data are non-delayed data with level 3. For example, if the remaining delay budget >T3 or the remaining delay budget ≥T3, the buffered data may be considered as non-delayed data with a third level (may be represented as level 3), such as non-delayed data.

It is understood that the first level is higher than the second level, and the second level is higher than the third level. In some examples, data with a higher level is more urgent than data with a lower level.

In some example embodiments, a packet data convergence protocol (PDCP) entity of the terminal device 120 may determine whether the buffered data comprise delayed data. In some examples, the terminal device 120 may determine a delay or a remaining delay budget of the buffered data. For example, a delay timer at a PDCP layer may be started if a PDU set is arrived from an upper layer, accordingly, a time length of the delay timer may be regarded as a delay of the buffered data, and a difference between a maximum delay budget and the time length may be regarded as a remaining delay budget of the buffered data. In some examples, a PDU set may include multiple SDUs or PDUs, and the delay timer may be started at an arrival time of the first SDU/PDU belonging to the PDU set. It is understood that all SDUs or PDUs belonging to a same PDU set should share the delay timer, as such they have a same delay and a same remaining delay budget.

In some other example embodiments, the first threshold included in the configuration 212 may relate to a time length of a timer associated with a delay. For example, the first threshold may be configured for the PDCP entity of the terminal device 120.

In some examples, the terminal device 120 may start a timer associated with a packet upon a reception of the packet from an upper layer, where a time length of the timer may be set as the first threshold (T1). If the timer expires, the terminal device 120 may determine that the packet is delayed data. For example, if the timer expires and the packet is stilled buffered, then the buffered data including the packet are delayed data. If the timer does not expire, the terminal device 120 may determine that the packet is non-delayed data. For example, if the timer is still working and the packet is stilled buffered, then the buffered data including the packet are non-delayed data. It is understood that all SDUs or PDUs belonging to a same PDU set should share the timer.

In some examples, the buffered data in the LCH may not include delayed data, in other words, the buffered data are non-delayed data, and the terminal device 120 may perform an LCP procedure in a conventional way. For example, a priority value of the LCH may be determined based on an information element (IE) “priority”. In a specific example, as shown in FIG. 2, the terminal device 120 determines 220 that the buffered data include delayed data.

The terminal device 120 determines 230 a priority value of the logical channel. For example, the terminal device 120 may increase a priority order of the LCH with delayed data.

In some example embodiments, a delayed data priority may be configured, for example, an IE “delayedDataPriority” or an IE “offset” may be configured to indicate a priority of the LCH with delayed data, or to indicate a relative priority (relative to the IE “priority”) of the LCH with delayed data. For ease of description, it is assumed that the IE “delayedDataPriority” or the IE “offset” includes the delayed data priority.

In some examples, the terminal device 120 may determine a priority value of the logical channel based on the delayed data priority. For example, if the logical channel (such as LCH1) includes delayed data, the priority value of the logical channel (such as LCH1) may be the delayed data priority indicated by the IE “delayedDataPriority” or the IE “offset”. For example, if the logical channel does not include delayed data, the priority value of the logical channel may be a priority indicated by the IE “priority”.

In some other examples, if the delayed data priority is not configured, that is, there is no IE “delayedDataPriority” or “offset”, the terminal device 120 may determine a priority value of the logical channel as a priority indicated by the IE “priority”, for example, regardless whether there are delayed data.

In some examples, priority value of the logical channel may include a first priority value for delayed data and a second priority value for non-delayed data. For example, if the buffered data of the logical channel include delayed data and non-delayed data, the terminal device 120 may determine a first priority value of the delayed data and a second priority value of the non-delayed data, where the first priority value indicates a higher priority than the second priority value. For example, the first priority value may be the delayed data priority indicated by the IE “delayedDataPriority” or the IE “offset”. For example, the second priority value may be the priority indicated by the IE “priority”.

In some examples, if the buffered data of the logical channel include delayed data and non-delayed data, the LCH may be considered as two sub logical channels, one with delayed data and the other with non-delayed data. One sub logical channel with delayed data may have a first priority value, and the other one sub logical channel with non-delayed data may have a second priority value.

In some example embodiments, the terminal device 120 may determine different priority values for data with different delay levels (levels for brief). For example, the configuration 212 may include more than 1 threshold (such as N thresholds, where N is an integer larger than 1) and multiple priority values (such as N+1 priority values). As such, different priority values may be assigned for different delay levels. In some examples, the configuration 212 includes two thresholds, such as the first and second thresholds or the first and third thresholds discussed above, and may further include three priority values, such as value 1, value 2, and value 3. For example, value 1 may indicate a higher priority level, value 2 may indicate a middle priority level, and value 3 may indicate a lower priority level. For example, value 3 may be the priority indicated by the IE “priority”.

In some examples, the delayed data with a first level (such as urgent delayed data) may use value 1, i.e., the higher priority level. In some examples, the delayed data with a second level (such as non-urgent delayed data) may use value 2, i.e., the middle priority level. In some examples, the non-delayed data with a third level (such as non-delayed data) may use value 3, i.e., the lower priority level.

In some examples, the logical channel may be considered as multiple sub logical channels, such as N+1 sub logical channels, each with a corresponding priority value.

In some example embodiments, the network device 110 may transmit an indication indicating whether the delayed data should be multiplexed with a higher priority than non-delayed data. In some examples, the indication may be carried in a new field of downlink control information (DCI), a random access response (RAR) carrying an uplink grant, or an RRC message. In some examples, the indication may be carried in another IE in the RRC message, where the RRC message may be RRC signalling with configured grant Type 1 or Type 2.

Accordingly, the terminal device 120 may receive the indication. In some examples, if the indication indicates that the delayed data should be multiplexed with a higher priority than the non-delayed data, the terminal device 120 may multiplex the delayed data with a higher priority than the non-delayed data. For example, the higher priority may be a delayed data priority indicated by the IE “delayedDataPriority” or the IE “offset”. In some other examples, if the indication indicates that the delayed data should not be multiplexed with a higher priority than the non-delayed data, or if the indication does not exist, the terminal device 120 may multiplex the data in a legacy way. For example, a priority indicated by the IE “priority” may be used. For example, the indication does not exist may refer to: the field or the IE carrying the indication does not exist.

In some example embodiments, the terminal device 120 may increase a priority order of a logical channel with delayed data by a step. In some examples, the terminal device 120 may determine a priority value of the logical channel based on a priority indicated by the IE “priority” and may further determine a priority order (such as an initial order) for the logical channel. In some examples, if the logical channel is a LCH with delayed data, the priority order may be increased by a step. In some examples, the value of the step may be pre-defined or may be configured by the network device 110. In some examples, if the delayed data of the logical channel has been multiplexed, in other words, if the logical channel no longer is a LCH with delayed data, the priority order may be reset (decrease) to the initial order.

In some examples, multiple steps may be used for respective delayed data, for example, different steps may be associated with delayed data with different levels. In some examples, the terminal device 120 may determine different steps for delayed data with different levels. In some examples, the terminal device 120 may increase different priority orders of delayed data with different levels by different steps, that is, the priority orders for delayed data with different levels may be increased by different steps. For example, the step used for delayed data with a first level may be larger than that for delayed data with a second level. For example, the step used for delayed data with a larger delay or a less remaining delay budget may be larger than that for delayed data with a smaller delay or a more remaining delay budget.

In some example embodiments, there may be two configuration sets associated with the logical channel received from by the network device 110, such as a first configuration set (set 1) and a second configuration set (set 2), where the first configuration set may be associated with delayed data, and the second configuration set may be associated with non-delayed data. In some examples, each of the configuration sets may include one or more of parameters, such as: a priority, a prioritized bit rate, a bucket size duration, or a logical channel group.

In some examples, the terminal device 120 may use the parameters in the first configuration set for delayed data or for a logical channel with delayed data. In some examples, the terminal device 120 may use the parameters in the second configuration set for non-delayed data or for a logical channel without delayed data. It is understood that at least one of the parameters (a priority, a prioritized bit rate, or a bucket size duration) may be different for delayed data and non-delayed data.

It is to be understood that although only two configuration sets are discussed in the present disclosure, more configuration sets may be used for different delay levels. For brevity, the embodiments with more configuration sets will not be discussed in detail in the present disclosure.

Continue referring to FIG. 2, the terminal device 120 performs 240 an LCP procedure. In some examples, the MAC entity of the terminal device 120 may determine a delayed buffer size of the delayed data of the LCH, and the MAC entity may allocate resources for the delayed data.

In some examples, there may be multiple logical channels with buffered data, the terminal device 120 may determine a priority order of the multiple logical channels according to the priority values of respective logical channels, and may further allocate resources for the multiple logical channels in a decreasing priority order.

In some example embodiments, delayed data should be served before non-delayed data when performing the LCP procedure. In some examples, there may be more than two logical channels with delayed data, and the MAC entity may allocate resources for the delayed data in a decreasing priority order. In some examples, if any resources remain, all logical channel with Bj>0 are served in a decreasing priority order, where Bj is maintained for each logical channel j at the terminal device 120 and is used for the LCP procedure, as discussed above.

In some example embodiments, the terminal device 120 may follow one more of the rules during the LCP procedure: maximizing a transmission of the delayed data for the logical channel; or maximizing a transmission of a PDU set comprising the delayed data. For example, the terminal device 120 may maximize the transmission of delayed data for a logical channel, such as the logical channel configured with the first threshold). For example, the terminal device 120 may still allocate resources to the delayed data when Bj<0. For example, the terminal device 120 may maximize the transmission of a PDU set, that is, the PDU set shall be sent as a whole if possible.

In some example embodiments, the LCP procedure according to the present disclosure may be an update of the current LCP procedure, for example, the specification may be updated as:

The MAC entity shall, when a new transmission is performed:
1> allocate resources to the logical channels as follows:

| | |
|---|---|
| 2> | For each logical channel with delayed data, delayed data and non-delayed |
| | data shall use different priorities as configured or indicated, for example, |
| | the logical channel can be treated as 2 different logical channels: logical |
| | channel with delayed data and logical channel without delayed data. |
| 2> | logical channels selected in clause 5.4.3.1.2 for the UL grant with Bj > 0 |
| | are allocated resources in a decreasing priority order. If the PBR of a |
| | logical channel is set to infinity, the MAC entity shall allocate resources |
| | for all the data that is available for transmission on the logical channel |
| | before meeting the PBR of the lower priority logical channel(s); |
| 2> | decrement Bj by the total size of MAC SDUs served to logical channel j |
| | above; |
| 2> | if any resources remain, all the logical channels selected in clause 5.4.3.1.2 |
| | are served in a strict decreasing priority order (regardless of the value of |
| | Bj) until either the data for that logical channel or the UL grant is |
| | exhausted, whichever comes first. Logical channels configured with equal |
| | priority may be served equally. |
| NOTE 1: | The value of Bj can be negative. |
| NOTE 2: | Logical channels with delayed data may be served before Logical |

channels without delayed data when the priority is equal.

In addition or alternatively, the terminal device 120 may transmit 250 an uplink transmission 252 to the network device 110. In some examples, the terminal device 120 may transmit the buffered data using the allocated resources. In some examples, if delayed data are multiplexed in a MAC PDU (e.g., with a higher priority), an indication can be carried 10 in the MAC PDU to inform the network device 110. For example, the indication to the network device 110 may be carried in a MAC control element (CE). On the other side of communication, the network device 110 receives 254 the uplink transmission 252, such as delayed data multiplexed in a MAC PDU.

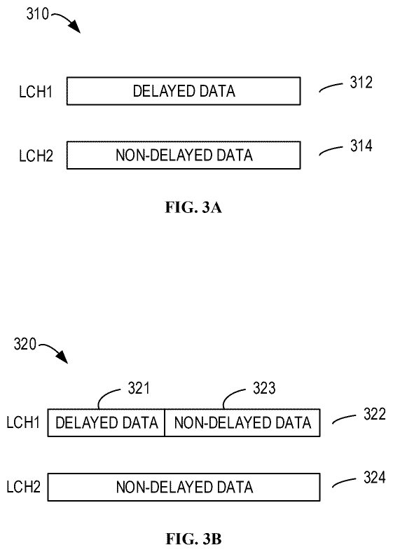

FIG. 3A illustrates a schematic diagram 310 of a scenario with two logical channels in accordance with some embodiments of the present disclosure. As shown in FIG. 3A, there are LCH 312 and LCH 314, where the LCH 312 has delayed data, and the LCH 314 has non-delayed data.

The priority of LCH 312 with delayed data may be higher than the priority of LCH 314 without delayed data. For example, the priority value of LCH 312 is determined based on the IE “delayedDataPriority” associated with LCH 312, and the priority value of LCH 314 is determined based on the IE “priority” associated with LCH 314.

The terminal device 120 may multiplex the delayed data in LCH 312, and then multiplex the non-delayed data in LCH 314.

FIG. 3B illustrates a schematic diagram 320 of a scenario with two logical channels in accordance with some embodiments of the present disclosure. As shown in FIG. 3B, there are LCH 322 and LCH 324, where the LCH 322 has delayed data and non-delayed data, and the LCH 324 has non-delayed data.

The LCH 322 may be regarded as two sub logical channels (SLCH): a sub logical channel with delayed data, i.e. SLCH 321; and a sub logical channel with non-delayed data, i.e., SLCH 323. The sub logical channel 321 with delayed data has a priority higher than the priority of LCH 324, and the sub logical channel 323 with non-delayed data has a priority lower than the priority of LCH 324. For example, the priority value of the sub logical channel 321 with delayed data of LCH 322 is determined based on the IE “delayedDataPriority” associated with LCH 322, the priority value of the sub logical channel 323 with non-delayed data of LCH 322 is determined based on the IE “priority” associated with LCH 322, and the priority value of LCH 324 is determined based on the IE “priority” associated with LCH 324.

The terminal device 120 may determine the priority order as: the sub logical channel 321, the LCH 324, and the sub logical channel 323. The terminal device 120 may multiplex the delayed data in LCH 322 first, then multiplex the non-delayed data in LCH 324, and multiplex the non-delayed data in LCH 322.

According to the example embodiments described with reference to FIGS. 2-3B, a configuration including at least one threshold may be used by the terminal device to distinguish delayed data and non-delayed data. The priority order of delayed data may be increased so that the delayed data should be multiplexed in a MAC PDU with a high priority, thus the transmission of delayed data may be guaranteed. Therefore, the latency requirements of the services may be met and the efficiency of a communication between the terminal device and the network device may be improved.

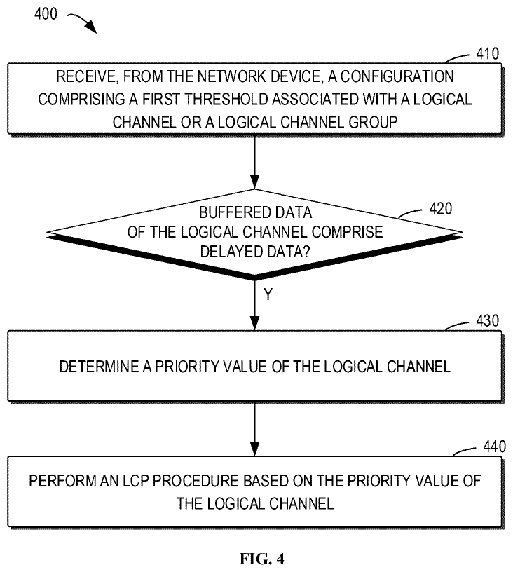

FIG. 4 illustrates a flowchart of an example method 400 implemented at a terminal device in accordance with some embodiments of the present disclosure. For the purpose of discussion, the method 400 will be described from the perspective of the terminal device 120 with reference to FIG. 1.

At block 410, the terminal device 120 receives, from the network device 110, a configuration comprising a first threshold associated with a logical channel or a logical channel group. At block 420, the terminal device 120 determines whether buffered data of the logical channel comprise delayed data based on the configuration. At block 430, if the buffered data of the logical channel comprise delayed data, the terminal device 120 determines a priority value of the logical channel. At block 440, the terminal device 120 performs a logical channel prioritization (LCP) procedure based on the priority value of the logical channel.

In some example embodiments, if a delay of the buffered data is not less than or exceeds the first threshold, the terminal device 120 determines that the buffered data are delayed data. In some example embodiments, if the delay of the buffered data is less than or not larger than the first threshold, the terminal device 120 determines that the buffered data are non-delayed data.

In some example embodiments, the configuration further comprises a second threshold being less than the first threshold, if a delay of the buffered data is not less than or exceeds the first threshold, the terminal device 120 determines that the buffered data are delayed data with a first level; if the delay of the buffered data is not less than or exceeds the second threshold and is less than or not larger than the first threshold, the terminal device 120 determines that the buffered data are delayed data with a second level, the second level is lower than the first level; or if the delay of the buffered data is less than or not larger than the second threshold, the terminal device 120 determines that the buffered data are non-delayed data with a third level, the third level is lower than the second level.

In some example embodiments, if a remaining delay budget of the buffered data is less than or not larger than the first threshold, the terminal device 120 determines that the buffered data are delayed data; or if the remaining delay budget of the buffered data is not less than or exceeds the first threshold, the terminal device 120 determines that the buffered data are non-delayed data.

In some example embodiments, the configuration further comprises a third threshold being larger than the first threshold, if a remaining delay budget of the buffered data is less than or not greater than the first threshold, the terminal device 120 determines that the buffered data are delayed data with a first level; if the remaining delay budget of the buffered data is not less than or exceeds the first threshold and is less than or not larger than the third threshold, the terminal device 120 determines that the buffered data are delayed data with a second level, the second level is lower than the first level; or if the remaining delay budget of the buffered data is not less than or exceeds the third threshold, the terminal device 120 determines that the buffered data are non-delayed data with a third level, the third level is lower than the second level.

In some example embodiments, the terminal device 120 starts a timer associated with a packet upon a reception of the packet from an upper layer, a time length of the timer is set as the first threshold; and if the timer expires, the terminal device 120 determines that the buffered data comprising the packet are delayed data; or if the timer does not expire, the terminal device 120 determines that the buffered data comprising the packet are non-delayed data.

In some example embodiments, the timer is shared by a plurality of service data units (SDU) or a plurality of protocol data units (PDU) in a same PDU set.

In some example embodiments, the terminal device 120 determines a delayed buffer size of the delayed data associated with the logical channel.

In some example embodiments, if the buffered data of the logical channel comprise delayed data and a delayed data priority is configured, the terminal device 120 determines the priority value of the logical channel based on the delayed data priority; or if the buffered data of the logical channel comprise delayed data and a delayed data priority is not configured, the terminal device 120 determines the priority value of the logical channel based on a configured priority.

In some example embodiments, if the buffered data of the logical channel comprise delayed data and non-delayed data, the terminal device 120 determines a first priority value of the delayed data and a second priority value of the non-delayed data, where the priority value comprises the first priority value and the second priority value, the first priority value indicates a higher priority than the second priority value.

In some example embodiments, the terminal device 120 determines different priority values for data with different levels.

In some example embodiments, the terminal device 120 receives, from the network device 110, an indication indicating whether the delayed data should be multiplexed with a higher priority than non-delayed data. In some example embodiments, if the indication indicates that the delayed data should be multiplexed with a higher priority than the non-delayed data, the terminal device 120 multiplexes the delayed data with a higher priority than the non-delayed data.

In some example embodiments, the indication is carried in at least one of: a DCI, an RAR carrying an uplink grant, or an RRC message.

In some example embodiments, if the buffered data of the logical channel comprise delayed data, the terminal device 120 increases a priority order of the logical channel by a step.

In some example embodiments, the terminal device 120 decreases the priority order after the delayed data have been multiplexed.

In some example embodiments, if the buffered data comprise delayed data with different levels, the terminal device 120 determines different steps for the delayed data with different levels. In In some example embodiments, the terminal device 120 increases different priority orders of delayed data with different levels by the different steps.

In some example embodiments, the buffered data comprise delayed data and non-delayed data, and the delayed data are served before the non-delayed data.

In some example embodiments, the terminal device 120 receives, from the network device 110, a first configuration set and a second configuration set each comprising at least one of: a priority, a prioritized bit rate, a bucket size duration, or a logical channel group, where the first configuration set is associated with delayed data, and the second configuration set is associated with non-delayed data.

In some example embodiments, the terminal device 120 maximizes a transmission of the delayed data for the logical channel. In some example embodiments, the terminal device 120 maximizes a transmission of a PDU set comprising the delayed data.

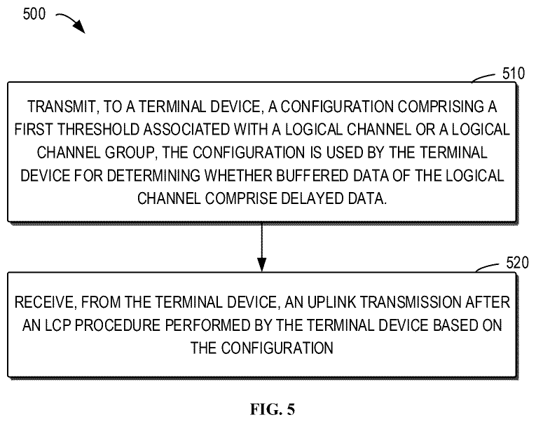

FIG. 5 illustrates a flowchart of an example method 500 implemented at a network device in accordance with some embodiments of the present disclosure. For the purpose of discussion, the method 500 will be described from the perspective of the network device 110 with reference to FIG. 1.

At block 510, the network device 110 transmits, to a terminal device 120, a configuration comprising a first threshold associated with a logical channel or a logical channel group, the configuration is used by the terminal device for determining whether buffered data of the logical channel comprise delayed data. At block 520, the network device 110 receives, from the terminal device, an uplink transmission after a logical channel prioritization (LCP) procedure performed by the terminal device based on the configuration.

In some example embodiments, the first threshold indicates a threshold of a delay of the buffered data or a remaining delay budget of the buffered data.

In some example embodiments, the configuration further comprises a second threshold being less than the first threshold, where the second threshold indicates a further threshold of the delay of the buffered data, and where the first threshold and the second threshold are used for determining different delay levels.

In some example embodiments, the configuration further comprises a third threshold being larger than the first threshold, where the third threshold indicates a further threshold of the remaining delay budget of the buffered data, and where the first threshold and the third threshold are used for determining different delay levels.

In some example embodiments, the first threshold indicates a time length of a timer for a packet buffered.

In some example embodiments, the timer is shared by a plurality of service data units (SDU) or a plurality of protocol data units (PDU) in a same PDU set.

In some example embodiments, the network device 110 transmits, to the terminal device 120, a further configuration comprising a delayed data priority associated with the logical channel or the logical channel group, the delayed data priority is used for determining a priority value of the logical channel.

In some example embodiments, the network device 110 transmits, to the terminal device 120, a plurality of priorities or a plurality of steps corresponding to the different delay levels.

In some example embodiments, the network device 110 transmits, to the terminal device 120, an indication indicating whether the delayed data should be multiplexed with a higher priority than non-delayed data. In some example embodiments, the indication is carried in at least one of: a DCI, an RAR carrying an uplink grant, or an RRC message.

In some example embodiments, the buffered data comprise delayed data and non-delayed data, and the delayed data are served before the non-delayed data.

In some example embodiments, the network device 110 transmits, to the terminal device 120, a first configuration set and a second configuration set each comprising at least one of: a priority, a prioritized bit rate, a bucket size duration, or a logical channel group, where the first configuration set is associated with delayed data, and the second configuration set is associated with non-delayed data.

Details of some embodiments according to the present disclosure have been described with reference to FIGS. 1-5. Now an example implementation of the terminal device and the network device will be discussed below.

In some example embodiments, a terminal device comprises circuitry configured to: receive, from a network device, a configuration comprising a first threshold associated with a logical channel or a logical channel group; determine whether buffered data of the logical channel comprise delayed data based on the configuration; in accordance with a determination that the buffered data of the logical channel comprise delayed data, determine a priority value of the logical channel; and perform a logical channel prioritization (LCP) procedure based on the priority value of the logical channel.

In some example embodiments, the terminal device comprises circuitry configured to: in accordance with a determination that a delay of the buffered data is not less than or exceeds the first threshold, determine that the buffered data are delayed data; or in accordance with a determination that the delay of the buffered data is less than or not larger than the first threshold, determine that the buffered data are non-delayed data.

In some example embodiments, the configuration further comprises a second threshold being less than the first threshold, and the terminal device comprises circuitry configured to: in accordance with a determination that a delay of the buffered data is not less than or exceeds the first threshold, determine that the buffered data are delayed data with a first level; in accordance with a determination that the delay of the buffered data is not less than or exceeds the second threshold and is less than or not larger than the first threshold, determine that the buffered data are delayed data with a second level, the second level is lower than the first level; or in accordance with a determination that the delay of the buffered data is less than or not larger than the second threshold, determine that the buffered data are non-delayed data with a third level, the third level is lower than the second level.

In some example embodiments, the terminal device comprises circuitry configured to: in accordance with a determination that a remaining delay budget of the buffered data is less than or not larger than the first threshold, determine that the buffered data are delayed data; or in accordance with a determination that the remaining delay budget of the buffered data is not less than or exceeds the first threshold, determine that the buffered data are non-delayed data.

In some example embodiments, the configuration further comprises a third threshold being larger than the first threshold, and the terminal device comprises circuitry configured to: in accordance with a determination that a remaining delay budget of the buffered data is less than or not greater than the first threshold, determine that the buffered data are delayed data with a first level; in accordance with a determination that the remaining delay budget of the buffered data is not less than or exceeds the first threshold and is less than or not larger than the third threshold, determine that the buffered data are delayed data with a second level, the second level is lower than the first level; or in accordance with a determination that the remaining delay budget of the buffered data is not less than or exceeds the third threshold, determine that the buffered data are non-delayed data with a third level, the third level is lower than the second level.

In some example embodiments, the terminal device comprises circuitry configured to: start a timer associated with a packet upon a reception of the packet from an upper layer, a time length of the timer is set as the first threshold; and in accordance with a determination that the timer expires, determine that the buffered data comprising the packet are delayed data; or in accordance with a determination that the timer does not expire, determine that the buffered data comprising the packet are non-delayed data.

In some example embodiments, the timer is shared by a plurality of service data units (SDU) or a plurality of protocol data units (PDU) in a same PDU set.

In some example embodiments, the terminal device comprises circuitry configured to: determine a delayed buffer size of the delayed data associated with the logical channel.

In some example embodiments, the terminal device comprises circuitry configured to: in accordance with a determination that the buffered data of the logical channel comprise delayed data and a delayed data priority is configured, determine the priority value of the logical channel based on the delayed data priority; or in accordance with a determination that the buffered data of the logical channel comprise delayed data and a delayed data priority is not configured, determine the priority value of the logical channel based on a configured priority.

In some example embodiments, the terminal device comprises circuitry configured to determine the priority value of the logical channel by: in accordance with a determination that the buffered data of the logical channel comprise delayed data and non-delayed data, determining a first priority value of the delayed data and a second priority value of the non-delayed data, wherein the priority value comprises the first priority value and the second priority value, the first priority value indicates a higher priority than the second priority value.

In some example embodiments, the terminal device comprises circuitry configured to determine the priority value of the logical channel by: determining different priority values for data with different levels.

In some example embodiments, the terminal device comprises circuitry configured to: receive, from the network device, an indication indicating whether the delayed data should be multiplexed with a higher priority than non-delayed data; and in accordance with a determination that the indication indicates that the delayed data should be multiplexed with a higher priority than the non-delayed data, multiplex the delayed data with a higher priority than the non-delayed data.

In some example embodiments, the indication is carried in at least one of: downlink control information (DCI), a random access response (RAR) carrying an uplink grant, or a radio resource control (RRC) message.

In some example embodiments, the terminal device comprises circuitry configured to: in accordance with a determination that the buffered data of the logical channel comprise delayed data, increase a priority order of the logical channel by a step.

In some example embodiments, the terminal device comprises circuitry configured to: decrease the priority order after the delayed data have been multiplexed.

In some example embodiments, the terminal device comprises circuitry configured to: in accordance with a determination that the buffered data comprise delayed data with different levels, determine different steps for the delayed data with different levels; and/or increase different priority orders of delayed data with different levels by the different steps.

In some example embodiments, the buffered data comprise delayed data and non-delayed data, and the delayed data are served before the non-delayed data.

In some example embodiments, the terminal device comprises circuitry configured to: receive, from the network device, a first configuration set and a second configuration set each comprising at least one of: a priority, a prioritized bit rate, a bucket size duration, or a logical channel group, wherein the first configuration set is associated with delayed data, and the second configuration set is associated with non-delayed data.

In some example embodiments, the terminal device comprises circuitry configured to: maximize a transmission of the delayed data for the logical channel; or maximize a transmission of a PDU set comprising the delayed data.

In some example embodiments, a network device comprises circuitry configured to: transmit, to a terminal device, a configuration comprising a first threshold associated with a logical channel or a logical channel group, the configuration being used by the terminal device for determining whether buffered data of the logical channel comprise delayed data; and receive, from the terminal device, an uplink transmission after a logical channel prioritization (LCP) procedure performed by the terminal device based on the configuration.

In some example embodiments, the first threshold indicates a threshold of a delay of the buffered data or a remaining delay budget of the buffered data.

In some example embodiments, the configuration further comprises a second threshold being less than the first threshold, wherein the second threshold indicates a further threshold of the delay of the buffered data, and wherein the first threshold and the second threshold are used for determining different delay levels.

In some example embodiments, the configuration further comprises a third threshold being larger than the first threshold, wherein the third threshold indicates a further threshold of the remaining delay budget of the buffered data, and wherein the first threshold and the third threshold are used for determining different delay levels.

In some example embodiments, the first threshold indicates a time length of a timer for a packet buffered.

In some example embodiments, the timer is shared by a plurality of service data units (SDU) or a plurality of protocol data units (PDU) in a same PDU set.

In some example embodiments, the network device comprises circuitry configured to: transmit, to the terminal device, a further configuration comprising a delayed data priority associated with the logical channel or the logical channel group, the delayed data priority is used for determining a priority value of the logical channel.

In some example embodiments, the network device comprises circuitry configured to: transmit, to the terminal device, a plurality of priorities or a plurality of steps corresponding to the different delay levels.

In some example embodiments, the network device comprises circuitry configured to: transmit, to the terminal device, an indication indicating whether the delayed data should be multiplexed with a higher priority than non-delayed data.

In some example embodiments, the indication is carried in at least one of: downlink control information (DCI), a random access response (RAR) carrying an uplink grant, or a radio resource control (RRC) message.

In some example embodiments, the buffered data comprise delayed data and non-delayed data, and the delayed data are served before the non-delayed data.

In some example embodiments, the network device comprises circuitry configured to: transmit, to the terminal device, a first configuration set and a second configuration set each comprising at least one of: a priority, a prioritized bit rate, a bucket size duration, or a logical channel group, wherein the first configuration set is associated with delayed data, and the second configuration set is associated with non-delayed data.

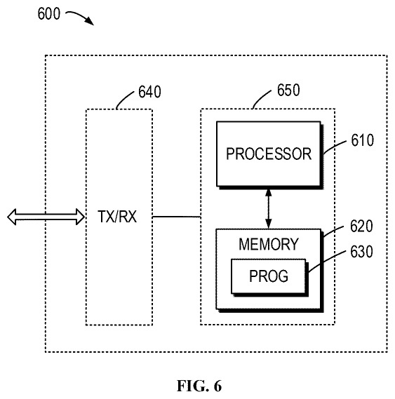

FIG. 6 illustrates a simplified block diagram of a device 600 that is suitable for implementing embodiments of the present disclosure. The device 600 can be considered as a further example implementation of the terminal device 120, and the network device 110 as shown in FIG. 1. Accordingly, the device 600 can be implemented at or as at least a part of the terminal device 120, or the network device 110.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 610 stores at least a part of a program 630. The TX/RX 640 is for bidirectional communications. The TX/RX 640 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 630 is assumed to include program instructions that, when executed by the associated processor 610, enable the device 600 to operate in accordance with the embodiments of the present disclosure, as discussed herein with reference to FIGS. 1-5.

The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

In summary, embodiments of the present disclosure may provide the following solutions.

The present disclosure provides a terminal device, comprising at least one processor configured to cause the terminal device at least to: receive, from a network device, a configuration comprising a first threshold associated with a logical channel or a logical channel group; determine whether buffered data of the logical channel comprise delayed data based on the configuration; in accordance with a determination that the buffered data of the logical channel comprise delayed data, determine a priority value of the logical channel; and perform a logical channel prioritization (LCP) procedure based on the priority value of the logical channel.

In one embodiment, the terminal device as above, the terminal device is further caused to: in accordance with a determination that a delay of the buffered data is not less than or exceeds the first threshold, determine that the buffered data are delayed data; or in accordance with a determination that the delay of the buffered data is less than or not larger than the first threshold, determine that the buffered data are non-delayed data.

In one embodiment, the terminal device as above, the configuration further comprises a second threshold being less than the first threshold, and wherein the terminal device is further caused to: in accordance with a determination that a delay of the buffered data is not less than or exceeds the first threshold, determine that the buffered data are delayed data with a first level; in accordance with a determination that the delay of the buffered data is not less than or exceeds the second threshold and is less than or not larger than the first threshold, determine that the buffered data are delayed data with a second level, the second level is lower than the first level; or in accordance with a determination that the delay of the buffered data is less than or not larger than the second threshold, determine that the buffered data are non-delayed data with a third level, the third level is lower than the second level.

In one embodiment, the terminal device as above, the terminal device is further caused to: in accordance with a determination that a remaining delay budget of the buffered data is less than or not larger than the first threshold, determine that the buffered data are delayed data; or in accordance with a determination that the remaining delay budget of the buffered data is not less than or exceeds the first threshold, determine that the buffered data are non-delayed data.

In one embodiment, the terminal device as above, the configuration further comprises a third threshold being larger than the first threshold, and wherein the terminal device is further caused to: in accordance with a determination that a remaining delay budget of the buffered data is less than or not greater than the first threshold, determine that the buffered data are delayed data with a first level; in accordance with a determination that the remaining delay budget of the buffered data is not less than or exceeds the first threshold and is less than or not larger than the third threshold, determine that the buffered data are delayed data with a second level, the second level is lower than the first level; or in accordance with a determination that the remaining delay budget of the buffered data is not less than or exceeds the third threshold, determine that the buffered data are non-delayed data with a third level, the third level is lower than the second level.

In one embodiment, the terminal device as above, the terminal device is further caused to: start a timer associated with a packet upon a reception of the packet from an upper layer, a time length of the timer is set as the first threshold; and in accordance with a determination that the timer expires, determine that the buffered data comprising the packet are delayed data; or in accordance with a determination that the timer does not expire, determine that the buffered data comprising the packet are non-delayed data.

In one embodiment, the terminal device as above, the timer is shared by a plurality of service data units (SDU) or a plurality of protocol data units (PDU) in a same PDU set.

In one embodiment, the terminal device as above, the terminal device is further caused to: determine a delayed buffer size of the delayed data associated with the logical channel.

In one embodiment, the terminal device as above, the terminal device is caused to determine the priority value of the logical channel by: in accordance with a determination that the buffered data of the logical channel comprise delayed data and a delayed data priority is configured, determining the priority value of the logical channel based on the delayed data priority; or in accordance with a determination that the buffered data of the logical channel comprise delayed data and a delayed data priority is not configured, determining the priority value of the logical channel based on a configured priority.

In one embodiment, the terminal device as above, the terminal device is caused to determine the priority value of the logical channel by: in accordance with a determination that the buffered data of the logical channel comprise delayed data and non-delayed data, determining a first priority value of the delayed data and a second priority value of the non-delayed data, wherein the priority value comprises the first priority value and the second priority value, the first priority value indicates a higher priority than the second priority value.

In one embodiment, the terminal device as above, the terminal device is caused to determine the priority value of the logical channel by: determining different priority values for data with different levels.

In one embodiment, the terminal device as above, the terminal device is further caused to: receive, from the network device, an indication indicating whether the delayed data should be multiplexed with a higher priority than non-delayed data; and in accordance with a determination that the indication indicates that the delayed data should be multiplexed with a higher priority than the non-delayed data, multiplex the delayed data with a higher priority than the non-delayed data.

In one embodiment, the terminal device as above, the indication is carried in at least one of: downlink control information (DCI), a random access response (RAR) carrying an uplink grant, or a radio resource control (RRC) message.

In one embodiment, the terminal device as above, the terminal device is further caused to: in accordance with a determination that the buffered data of the logical channel comprise delayed data, increase a priority order of the logical channel by a step.

In one embodiment, the terminal device as above, the terminal device is further caused to: decrease the priority order after the delayed data have been multiplexed.

In one embodiment, the terminal device as above, the terminal device is further caused to perform at least one of: in accordance with a determination that the buffered data comprise delayed data with different levels, determining different steps for the delayed data with different levels; or increasing different priority orders of delayed data with different levels by the different steps.

In one embodiment, the terminal device as above, the buffered data comprise delayed data and non-delayed data, and the delayed data are served before the non-delayed data.

In one embodiment, the terminal device as above, the terminal device is further caused to: receive, from the network device, a first configuration set and a second configuration set each comprising at least one of: a priority, a prioritized bit rate, a bucket size duration, or a logical channel group, wherein the first configuration set is associated with delayed data, and the second configuration set is associated with non-delayed data.

In one embodiment, the terminal device as above, the terminal device is caused to perform the LCP procedure by: maximizing a transmission of the delayed data for the logical channel; or maximizing a transmission of a PDU set comprising the delayed data.

The present disclosure provides a network device, comprising at least one processor configured to cause the network device at least to: transmit, to a terminal device, transmit, to a terminal device, a configuration comprising a first threshold associated with a logical channel or a logical channel group, the configuration being used by the terminal device for determining whether buffered data of the logical channel comprise delayed data; and receive, from the terminal device, an uplink transmission after a logical channel prioritization (LCP) procedure performed by the terminal device based on the configuration.

In one embodiment, the network device as above, the first threshold indicates a threshold of a delay of the buffered data or a remaining delay budget of the buffered data.

In one embodiment, the network device as above, the configuration further comprises a second threshold being less than the first threshold, wherein the second threshold indicates a further threshold of the delay of the buffered data, and wherein the first threshold and the second threshold are used for determining different delay levels.

In one embodiment, the network device as above, the configuration further comprises a third threshold being larger than the first threshold, wherein the third threshold indicates a further threshold of the remaining delay budget of the buffered data, and wherein the first threshold and the third threshold are used for determining different delay levels.

In one embodiment, the network device as above, the first threshold indicates a time length of a timer for a packet buffered.

In one embodiment, the network device as above, the timer is shared by a plurality of service data units (SDU) or a plurality of protocol data units (PDU) in a same PDU set.

In one embodiment, the network device as above, the network device is further caused to: transmit, to the terminal device, a further configuration comprising a delayed data priority associated with the logical channel or the logical channel group, the delayed data priority is used for determining a priority value of the logical channel.

In one embodiment, the network device as above, the network device is further caused to: transmit, to the terminal device, a plurality of priorities or a plurality of steps corresponding to the different delay levels.

In one embodiment, the network device as above, the network device is further caused to: transmit, to the terminal device, an indication indicating whether the delayed data should be multiplexed with a higher priority than non-delayed data.

In one embodiment, the network device as above, the indication is carried in at least one of: downlink control information (DCI), a random access response (RAR) carrying an uplink grant, or a radio resource control (RRC) message.

In one embodiment, the network device as above, the buffered data comprise delayed data and non-delayed data, and the delayed data are served before the non-delayed data.

In one embodiment, the network device as above, the network device is further caused to: transmit, to the terminal device, a first configuration set and a second configuration set each comprising at least one of: a priority, a prioritized bit rate, a bucket size duration, or a logical channel group, wherein the first configuration set is associated with delayed data, and the second configuration set is associated with non-delayed data.

The present disclosure provides a method of communication, comprising the operations implemented at the terminal device discussed above.

The present disclosure provides a method of communication, comprising the operations implemented at the network device discussed above.

The present disclosure provides a terminal device, comprising: a processor; and a memory storing computer program codes; the memory and the computer program codes configured to, with the processor, cause the terminal device to perform the method implemented at the terminal device discussed above.

The present disclosure provides a network device, comprising: a processor; and a memory storing computer program codes; the memory and the computer program codes configured to, with the processor, cause the network device to perform the method implemented at the network device discussed above.

The present disclosure provides a computer readable medium having instructions stored thereon, the instructions, when executed by a processor of an apparatus, causing the apparatus to perform the method implemented at a terminal device or a network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method of a terminal device, the method comprising:
receiving, from a network device by an RRC message, a configuration having a first threshold associated with a logical channel;
determining that Packet data convergence protocol (PDCP) data associated with the logical channel is delayed data based on a remaining delay budget of the PDCP data being less than the first threshold;
in accordance with a determination that the PDCP data is delayed data, determining a priority value of the logical channel; and
performing a logical channel prioritization (LCP) procedure based on the priority value.

22. The method of the terminal device according to claim 21, further comprising:
determining that the PDCP data is delayed data in accordance with a determination that a delay of the PDCP data exceeds the first threshold;
determining that the PDCP data is non-delayed data in accordance with a determination that the delay of the PDCP data is less than or equal to the first threshold;
determining that the PDCP data is delayed data in accordance with a determination that the remaining delay budget of the PDCP data is less than the first threshold; or
determining that the PDCP data is non-delayed data in accordance with a determination that the remaining delay budget of the PDCP data is more than or equal to the first threshold.

23. The method of the terminal device according to claim 21, wherein the configuration further comprises a second threshold being larger than the first threshold, and the method further comprising:
determining that the PDCP data is delayed data with a first level in accordance with a determination that the remaining delay budget of the PDCP data is less than or not more than the first threshold;
determining that the PDCP data is delayed data with a second level in accordance with a determination that the remaining delay budget of the PDCP data is not less than or exceeds the first threshold and is less than or not larger than the second threshold, wherein the second level is lower than the first level; or
determining that the PDCP data is non-delayed data with a third level in accordance with a determination that the remaining delay budget of the PDCP data is not less than or exceeds the second threshold, wherein the third level is lower than the second level.

24. The method of the terminal device according to claim 21, wherein
determining the priority value of the logical channel comprises:
determining the priority value of the logical channel based on a delayed data priority in accordance with a determination that the PDCP data of the logical channel comprises delayed data and the delayed data priority is configured; or
determining the priority value of the logical channel based on a configured priority in accordance with a determination that the PDCP data of the logical channel comprises delayed data and the delayed data priority is not configured; or
determining a first priority value of the delayed data and a second priority value of the non-delayed data in accordance with a determination that the PDCP data of the logical channel comprises delayed data and non-delayed data, wherein the priority value comprises the first priority value and the second priority value, and the first priority value indicates a higher priority than the second priority value.

25. The method of the terminal device according to claim 21, further comprising:
receiving, from the network device, an indication indicating whether the delayed data should be multiplexed with a higher priority than non-delayed data; and
multiplexing the delayed data with a higher priority than the non-delayed data in accordance with a determination that the indication indicates that the delayed data should be multiplexed with a higher priority than the non-delayed data, wherein the indication is carried in at least one of: downlink control information (DCI), a random access response (RAR) carrying an uplink grant, or a radio resource control (RRC) message.

26. The method of the terminal device according to claim 21, wherein the LCP procedure comprises at least one of:
determining a delayed buffer size of the delayed data associated with the logical channel;
maximizing a transmission of the delayed data for the logical channel; or
maximizing a transmission of a PDU set comprising the delayed data.

27. A method of a network device, the method comprising:
transmitting, to a terminal device by an RRC message, a configuration having a first threshold associated with a logical channel; the configuration being used by the terminal device for determining that Packet data convergence protocol (PDCP) data associated with the logical channel is delayed data based on a remaining delay budget of the PDCP data being less than the first threshold; and
receiving, from the terminal device, an uplink transmission after a logical channel prioritization (LCP) procedure performed by the terminal device based on the configuration.

28. The method of the network device according to claim 27, further comprising:
transmitting, to the terminal device, an indication indicating whether the delayed data should be multiplexed with a higher priority than non-delayed data; and
the delayed data with a higher priority than the non-delayed data is multiplexed in accordance with a determination that the indication indicates that the delayed data should be multiplexed with a higher priority than the non-delayed data, wherein the indication is carried in at least one of: downlink control information (DCI), a random access response (RAR) carrying an uplink grant, or a radio resource control (RRC) message.

29. The method of the network device according to claim 27, wherein the LCP procedure comprises at least one of:
determining a delayed buffer size of the delayed data associated with the logical channel;
maximizing a transmission of the delayed data for the logical channel; or
maximizing a transmission of a PDU set comprising the delayed data.

30. A terminal device, comprising:
a memory configured to store instructions; and
a processor configured to execute the instructions to:
receive, from a network device by an RRC message, a configuration having a first threshold associated with a logical channel;
determine that Packet data convergence protocol (PDCP) data associated with the logical channel is delayed data based on a remaining delay budget of the PDCP data being less than the first threshold;
in accordance with a determination that the PDCP data is delayed data, determine a priority value of the logical channel; and
perform a logical channel prioritization (LCP) procedure based on the priority value.

31. The terminal device according to claim 30, the instructions further comprising to:
determine that the PDCP data is delayed data in accordance with a determination that a delay of the PDCP data exceeds the first threshold;
determine that the PDCP data is non-delayed data in accordance with a determination that the delay of the PDCP data is less than or equal to the first threshold;
determine that the PDCP data is delayed data in accordance with a determination that the remaining delay budget of the PDCP data is less than the first threshold; or
determine that the PDCP data is non-delayed data in accordance with a determination that the remaining delay budget of the PDCP data is more than or equal to the first threshold.

32. The terminal device according to claim 30, wherein the configuration further comprises a second threshold being larger than the first threshold, and the instructions further comprising to:
determine that the PDCP data is delayed data with a first level in accordance with a determination that the remaining delay budget of the PDCP data is less than or not more than the first threshold;
determine that the PDCP data is delayed data with a second level in accordance with a determination that the remaining delay budget of the PDCP data is not less than or exceeds the first threshold and is less than or not larger than the second threshold, wherein the second level is lower than the first level; or
determine that the PDCP data is non-delayed data with a third level in accordance with a determination that the remaining delay budget of the PDCP data is not less than or exceeds the second threshold, wherein the third level is lower than the second level.

33. The terminal device according to claim 30, wherein the instruction to determine the priority value of the logical channel further comprising to:
determine the priority value of the logical channel based on a delayed data priority in accordance with a determination that the PDCP data of the logical channel comprises delayed data and the delayed data priority is configured; or
determine the priority value of the logical channel based on a configured priority in accordance with a determination that the PDCP data of the logical channel comprises delayed data and the delayed data priority is not configured; or
determine a first priority value of the delayed data and a second priority value of the non-delayed data in accordance with a determination that the PDCP data of the logical channel comprises delayed data and non-delayed data, wherein the priority value comprises the first priority value and the second priority value, and the first priority value indicates a higher priority than the second priority value.

34. The method of claim 30, the instructions further comprising to:
receive, from the network device, an indication indicating whether the delayed data should be multiplexed with a higher priority than non-delayed data; and
multiplex the delayed data with a higher priority than the non-delayed data in accordance with a determination that the indication indicates that the delayed data should be multiplexed with a higher priority than the non-delayed data, wherein the indication is carried in at least one of: downlink control information (DCI), a random access response (RAR) carrying an uplink grant, or a radio resource control (RRC) message.

35. The method of claim 30, wherein the LCP procedure comprises at least one of:
determining a delayed buffer size of the delayed data associated with the logical channel;
maximizing a transmission of the delayed data for the logical channel; or
maximizing a transmission of a PDU set comprising the delayed data.
